(19) United States
(12) Patent Application Publication
(10) Pub. No.: US 2025/0110450 A1
(43) Pub. Date: Apr. 3, 2025

(54) ELECTRONIC CIRCUIT, DISTANCE MEASUREMENT DEVICE, AND EQUIPMENT

(71) Applicant: CANON KABUSHIKI KAISHA, Tokyo (JP)

(72) Inventors: SATORU MIKAJIRI, Gunma (JP); YUJI NAKAJIMA, Tokyo (JP)

(21) Appl. No.: 18/826,465

(22) Filed: Sep. 6, 2024

(30) Foreign Application Priority Data
Sep. 28, 2023 (JP) 2023-168869

(51) Int. Cl. G04F 10/00; G01S 7/4863; G01S 7/4865; G01S 17/10; G04F 10/02

(52) U.S. Cl. CPC G04F 10/005; G01S 7/4865; G04F 10/02; G01S 7/4863; G01S 17/10

(57) ABSTRACT

An electronic circuit is provided. The electronic circuit includes a plurality of time-to-digital converters. Each of the plurality of time-to-digital converters includes a voltage-controlled oscillator configured to generate a multiphase clock. Each voltage-controlled oscillator includes a control transistor which is arranged between a first power supply line and a second power supply line and includes a gate to which a control voltage is input, and each voltage-controlled oscillator further includes a supply circuit configured to supply a current to the gate.

### BACKGROUND OF THE INVENTION

### Field of the Invention

The present disclosure relates to an electronic circuit, a distance measurement device, and equipment.

### Description of the Related Art

Japanese Patent Laid-Open No. 2023-069488 discloses a distance measurement device having a plurality of time-to-digital converters (TDCs) arranged so as to correspond to the pixels, of a plurality of pixels arranged in a two-dimensional lattice pattern, which are arranged in the respective columns.

Consider a case where the clock frequency is increased by inputting reference clocks to a plurality of TDCs and making each TDC generate a multiphase clock using a voltage-controlled oscillator. If, however, a current momentarily starts to flow in each TDC at the startup of the oscillator, the power-supply voltage for operating each TDC may vary. The variation in power-supply voltage may cause variation in control voltage for controlling the oscillation frequency of the oscillator. This may cause troubles in the operation of the TDC.

Some embodiments of the present disclosure are aimed at providing a technique advantageous for the stable operation of a time-to-digital converter.

### SUMMARY OF THE INVENTION

According to some embodiments, an electronic circuit comprising a plurality of time-to-digital converters, wherein each of the plurality of time-to-digital converters comprises a voltage-controlled oscillator configured to generate a multiphase clock, each voltage-controlled oscillator comprises a control transistor which is arranged between a first power supply line and a second power supply line and includes a gate to which a control voltage is input, and each voltage-controlled oscillator further comprises a supply circuit configured to supply a current to the gate, is provided.

Further features of the present invention will become apparent from the following description of exemplary embodiments (with reference to the attached drawings).

### BRIEF DESCRIPTION OF THE DRAWINGS

FIG. 1 is a view showing an example of the arrangement of a distance measurement device including an electronic circuit according to this embodiment;

FIG. 2 is a circuit diagram showing an example of the arrangement of a pixel arranged in the distance measurement device in FIG. 1;

FIG. 3 is a circuit diagram for explaining a problem in the oscillator of the electronic circuit in FIG. 1;

FIG. 4 is a circuit diagram showing an example of the arrangement of the oscillator of the electronic circuit in FIG. 1;

FIG. 5 is a circuit diagram showing an example of the arrangement of the oscillator of the electronic circuit in FIG. 1;

FIG. 6 is a timing chart showing an example of the operation of the oscillator of the electronic circuit in FIG. 1;

FIGS. 7A and 7B are circuit diagrams showing a modification of the oscillator of the electronic circuit in FIG. 1;

FIG. 8 is a timing chart showing an example of the operation of the oscillator of the electronic circuit in FIG. 7A; and

FIG. 9 is a view showing an example of the arrangement of equipment incorporating a photoelectric conversion device according to this embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

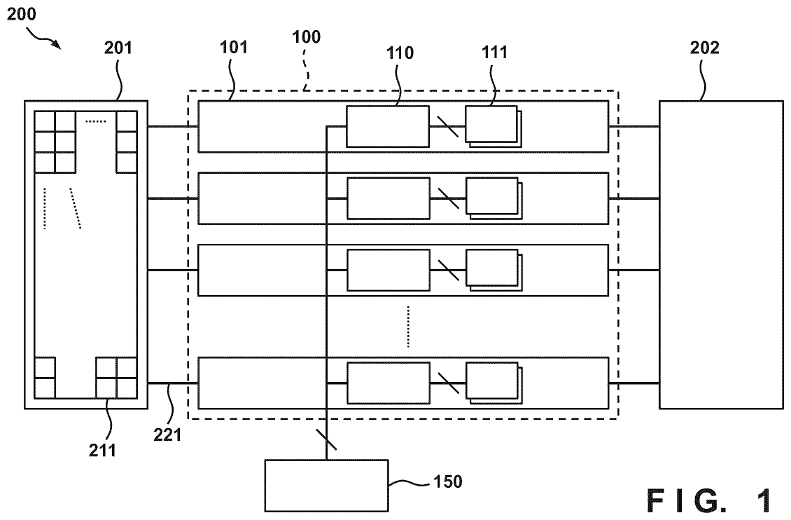

An electronic circuit according to an embodiment of the present disclosure will be described with reference to FIGS. 1 to 8. FIG. 1 is a block diagram schematically showing an example of the arrangement of a distance measurement device 200 including an electronic circuit 100 in this embodiment. The distance measurement device 200 can include a pixel circuit 201, an electronic circuit 100, a synchronization circuit 150, and a readout circuit 202.

A plurality of pixels 211 are arranged in the pixel circuit 201. The electronic circuit 100 and the synchronization circuit 150 are arranged to measure the time from the emission of light from a light source to the reception of light by the plurality of pixels 211. The readout circuit 202 reads out the data obtained by the electronic circuit 100 and supplies the data to an external device such as a personal computer. The external device obtains information such as a distance from the data obtained by the electronic circuit 100. The electronic circuit 100, the synchronization circuit 150, and the readout circuit 202 each form part of a generating circuit for generating distance information based on the signals obtained by the plurality of pixels 211.

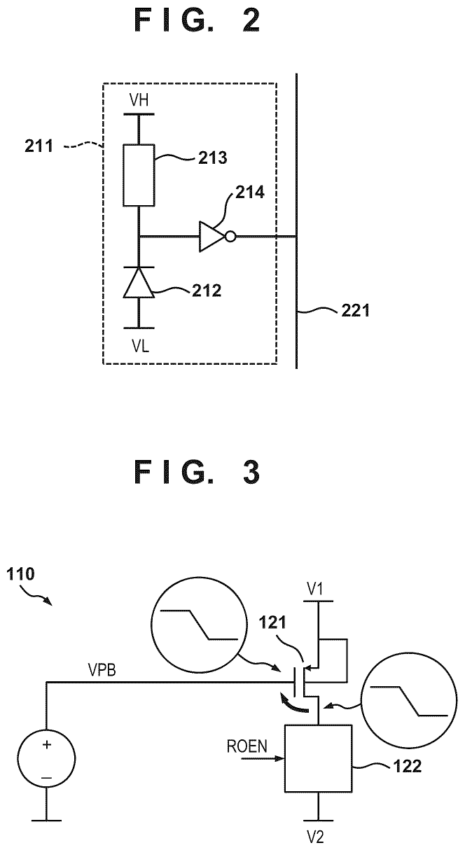

The pixels 211 arranged in the pixel circuit 201 are provided with photoelectric conversion elements for converting incident light into electrical signals. FIG. 2 is an example of a block diagram including an equivalent circuit of the pixel 211. This embodiment will exemplify a case where an avalanche photodiode (APD) 212 is used as a photoelectric conversion element. However, limitation is not made thereto, and a PN diode, a PIN diode, or the like may be used as a photoelectric conversion unit. The pixel 211 can be provided with, for example, a quench element 213 and a waveform shaping circuit 214 in addition to the APD 212.

The APD 212 generates an electric charge pair corresponding to incident light by photoelectric conversion. A potential VL is supplied to the anode of the APD 212. A potential VH higher than the potential VL supplied to the anode is supplied to the cathode of the APD 212. A reverse bias voltage is supplied to the APD 212 to cause avalanche breakdown. When such a reverse bias voltage is supplied to the APD 212, the electric charge generated by incident light causes avalanche breakdown to generate an avalanche current.

In supplying a reverse bias voltage to the APD 212, the APD 212 has a Geiger mode of operating based on the potential difference (voltage) between the anode and the cathode which is larger than the breakdown voltage and a linear mode of operating based on the potential difference between the anode and the cathode which is near the breakdown voltage or equal to or less than the breakdown voltage. An APD operating in the Geiger mode is called a Single Photon Avalanche Diode (SPAD). For example, the potential VL is −30 V, and the potential VH is 1 V. The APD 212 may operate either in the linear mode or the Geiger mode.

The quench element 213 is connected between the power supply that supplies the potential VH and the APD 212. The quench element 213 functions as a load circuit (quench circuit) at the time of signal multiplication by avalanche breakdown and serves to suppress avalanche breakdown by suppressing the voltage supplied to the APD 212 (quench operation). The quench element 213 also serves to restore the voltage supplied to the APD 212 to the voltage (VH-VL) by flowing a current corresponding to the voltage drop caused by the quench operation (recharge operation). The quench element 213 can be configured by a MOS transistor.

The waveform shaping circuit 214 shapes a potential change at the cathode of the APD 212 which is obtained at the time of photon detection and outputs a pulse signal. As the waveform shaping circuit 214, for example, an inverter circuit is used. The arrangement shown in FIG. 2 is an example using one inverter as the waveform shaping circuit 214. However, limitation is not made thereto, and a circuit having a plurality of inverters connected in series or another circuit having a waveform shaping effect may be used as the waveform shaping circuit 214. The pulse signal output from the waveform shaping circuit 214 is input to the electronic circuit 100 via a signal line 221.

The electronic circuit 100 includes a plurality of time-to-digital converters (TDCs) 101. The synchronization circuit 150 (which can also be called a PLL circuit) controls the plurality of TDCs 101. The plurality of TDCs 101 respectively receive the pulse signals output from the pixels 211, of the plurality of pixels 211 arranged in the pixel circuit 201, which are arranged in a corresponding column. Accordingly, each TDC 101 can be called a column TDC. Each TDC 101 converts the time difference between a start signal indicating the timing of the emission of light in the distance measurement device 200 and a pulse signal input from the pixel 211 into a digital signal in synchronization with a clock signal input from the synchronization circuit 150. It is possible to obtain distance information with respect to an object from this time difference.

Each TDC 101 includes a flip-flop (FF) circuit 111 for measuring a time difference. In addition, each TDC 101 includes voltage-controlled oscillator (VCO) 110 for generating a multiphase clock. Since each TDC 101 includes the VCO 110, a clock faster than the common clock input from the synchronization circuit 150 is supplied to the FF circuit 111 based on the common clock. This enables the distance measurement device 200 to perform distance measurement with higher accuracy than when using the common clock supplied from the synchronization circuit 150.

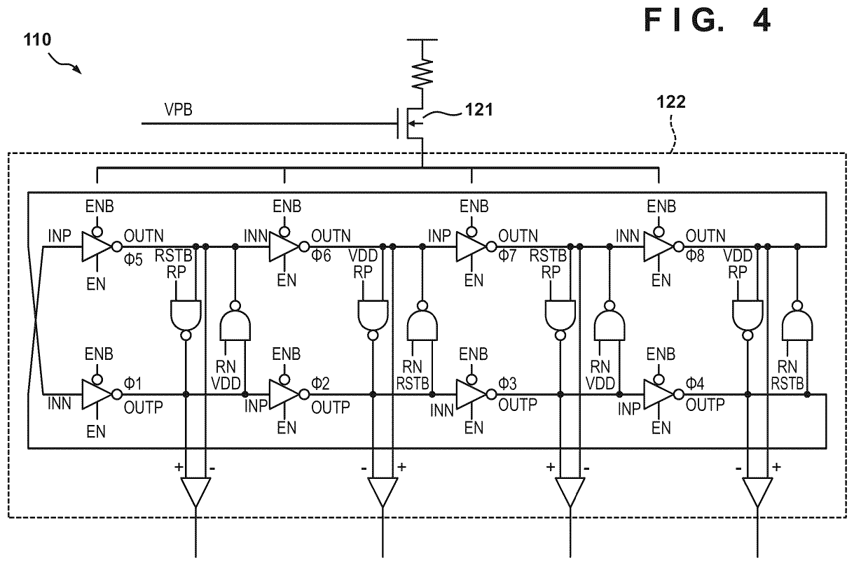

FIG. 3 is a block diagram showing an example of the arrangement of the VCO 110. FIG. 4 is a circuit diagram showing an example of the arrangement of the VCO 110. The VCO 110 includes a control transistor 121 arranged between a power supply line V1 and a power supply line V2 and having a gate to which a control voltage VPB is input and a ring oscillator 122 arranged between the control transistor 121 and the power supply line V2. The ring oscillator 122 is not limited to an 8-stage arrangement like that shown in FIG. 4, and any appropriate arrangement may be used as long as it can generate a clock faster than the common clock supplied from the synchronization circuit 150.

At the startup of the VCO 110, a current momentarily starts to flow between the power supply line V1 and the power supply line V2. For this reason, as shown in FIG. 3, at the startup of the VCO 110, the potential of the gate of the control transistor 121 can vary due to charge injection via the capacitance of the gate of the control transistor 121. That is, the control voltage VPB that controls the oscillation frequency of the VCO 110 can vary. In addition, power is supplied from the common synchronization circuit 150 to the plurality of TDCs 101 arranged in the electronic circuit 100. Accordingly, between the VCOs 110 arranged in the respective TDCs 101, voltage variation between the power supply line V1 and the power supply line V2 accompanying the startup of one of the VCOs 110 can appear as variation in the power supply voltage or the control voltage VPB supplied to the other VCO 110. That is, upon startup of the VCO 110 arranged in one of the TDCs 101, there is a possibility of crosstalk that affects the operation of the VCO 110 in the other TDC 101. If the control voltage VPB varies in the VCO 110, the oscillation frequency may vary, and the operation of the TDC 101 may become unstable, resulting in a deterioration in distance measurement accuracy.

Assume that the VCOs 110 are respectively arranged for the TDCs 101 arranged for each column. In this case, in order to suppress an increase in power consumption, the VCOs 110 arranged for the necessary TDCs 101 may be started first, and the VCOs 110 arranged for the remaining TDCs 101 may be started afterward. Such cases include a case where the TDCs 101 for calibration are operated first. In this case, starting the VCOs 110 after the calibration may cause crosstalk. In addition, if the plurality of TDCs 101 are started simultaneously, it may take time to stabilize the power supply voltage supplied from the synchronization circuit 150 and take time to set a standby state until distance measurement can be performed with high accuracy.

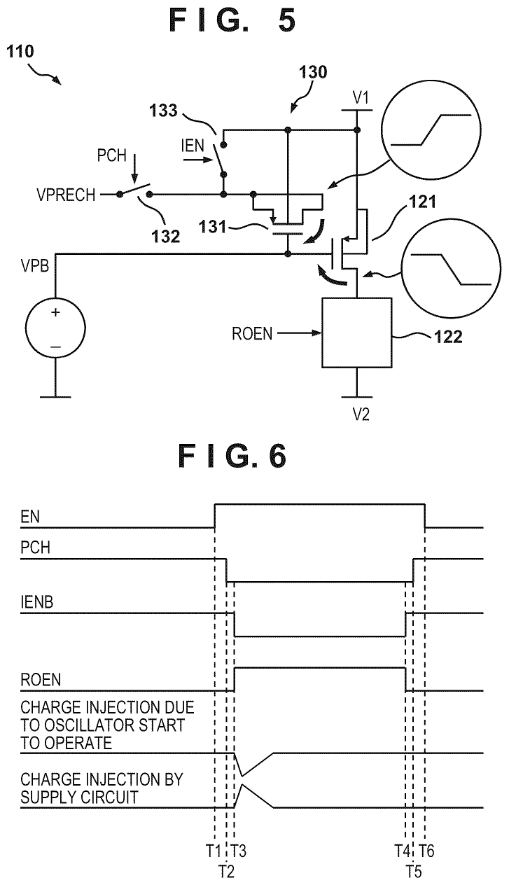

Accordingly, in this embodiment, as shown in FIG. 5, the VCO 110 arranged in each TDC 101 further includes a supply circuit 130 that supplies a current to the gate of the control transistor 121. FIG. 5 is a circuit diagram showing an example of the arrangement of the supply circuit 130.

The supply circuit 130 supplies a current to the gate of the control transistor 121 to reduce the variation in the potential of the gate of the control transistor 121 by charge injection via the gate at the startup of the VCO 110. The supply circuit 130 supplies, to the gate of the control transistor 121, a current in a direction opposite to that of a current flowing between the gate of the control transistor 121 and the supply circuit 130 due to charge injection at the startup of the VCO 110. Supplying the current in the opposite direction will suppress the variation in the potential of the gate of the control transistor 121, as indicated by the image of the potential surrounded by the circle in FIG. 5. This prevents the operation of the TDC 101 at the startup of the VCO 110 from becoming unstable. This further suppresses crosstalk with respect to the VCO 110 arranged in the other TDC 101. Assume that the VCO 110 arranged for each TDC 101 individually includes a terminal to which a signal for starting an operation is input, and the VCOs 110 are started at different timings as described above. Even in this case, it is possible to suppress crosstalk with respect to the other VCO 110.

The supply circuit 130 includes, for example, a capacitive element arranged between the power supply line V1 and the gate of the control transistor 121, a switch element 132 for charging the capacitive element, and a switch element 133 for supplying a current to the gate of the control transistor 121. More specifically, the supply circuit 130 includes a supply transistor 131 for supplying a current to the gate of the control transistor 121. The gate capacitance of the supply transistor 131 functions as a capacitive element arranged between the power supply line V1 and the gate of the control transistor 121. The source and the drain of the supply transistor 131 are connected to a power supply line VPRECH via the switch element 132 and are also connected to the power supply line VI via the switch element 133. The gate of the supply transistor 131 is connected to the gate of the control transistor 121. The body of the supply transistor 131 is connected to the power supply line V1. For example, the gate width of the supply transistor 131 may be half of the gate width of the control transistor 121. However, the arrangement of the supply circuit 130 is not limited to the arrangement shown in FIG. 5 as long as an appropriate current can be supplied to the gate of the control transistor 121. In the arrangement shown in FIG. 5, the same p-channel transistor as the control transistor 121 is used as the supply transistor 131 of the supply circuit 130. However, the control transistor 121 and the supply transistor 131 need not be of the same conductivity type. If, for example, the control transistor 121 is a p-channel transistor, the supply transistor 131 may be an n-channel transistor, and the circuit arrangement of the supply circuit 130 may be changed accordingly.

FIG. 6 is a timing chart focusing on the operation of the VCO 110 of one TDC 101. FIG. 6 shows control signals EN, PCH, IENB, and ROEN. The control signals EN, PCH, IENB, and ROEN each can be supplied from the synchronization circuit 150. The control signal EN is a signal that controls the overall operation of the TDC 101. When the control signal EN is set in the High state, the TDC 101 operates. The control signal PCH is a signal that controls the operation of the switch element 132. While the control signal PCH is in the High state, the switch element 132 is rendered conductive to charge the gate capacitance of the supply transistor 131. The control signal IENB is a signal that controls the operation of the switch element 133. The control signal IENB is a signal obtained by inverting a control signal IEN shown in FIG. 5. While the control signal IENB is in the Low state, the switch element 133 is rendered conductive. The control signal ROEN is a signal that controls the operation of the ring oscillator 122. When the control signal ROEN is set in the High state, the ring oscillator 122 operates. In other words, setting the control signal ROEN in the High state will make the VCO 110 operate.

At time T1, when the control signal EN is set in the High state, the TDC 101 starts to operate. The control signal PCH is in the High state before the control signal EN is supplied but may be set in the High state in response to the control signal EN being set in the High state. At time T2, the control signal PCH changes to the Low state. At time T3, the control signal IENB changes to the Low state, and the control signal ROEN changes to the High state. For example, the control signal PCH is a signal obtained by delaying the control signal EN by a predetermined time. The control signal IENB and the control signal ROEN are signals obtained by delaying the control signal EN by a predetermined time more than the control signal PCH. The control signal IENB and the control signal ROEN can be common signals whose states are displaced at the same timing. Accordingly, it can be said that in response to the common signal, the ring oscillator 122 starts to operate, and the supply circuit 130 starts to supply a current to the gate of the control transistor 121.

The ring oscillator 122 starts to operate in accordance with the control signal ROEN. That is, the VCO 110 is started up. At this time, as shown in FIG. 6, as the VCO 110 starts to operate (is started up), a charge injection current flows. Meanwhile, the switch element 133 is rendered conductive in accordance with the control signal IENB. This makes a charge injection current flow from the gate capacitance of the supply transistor 131 of the supply circuit 130. As a result, both the charge injection currents cancel out to suppress variation in the control voltage VPB and variation in power supply voltage supplied to each TDC 101.

Subsequently, at time T4, the control signal IENB changes to the High state, and the control signal ROEN changes to the Low state, thereby stopping the operation of the ring oscillator 122 (the VCO 110). At time T5, the control signal PCH may be set in the High state to charge the gate capacitance of the supply transistor 131 of the supply circuit 130 for the next operation of the VCO 110. At time T6, the control signal EN is set in the Low state to stop the operation of the TDC 101.

In this case, an interval is provided between time T2 and time T3 to prevent a through current from flowing as the switch element 132 and the switch element 133 are simultaneously rendered conductive. The same applies to the interval between time T4 and time T5.

In this manner, when the ring oscillator 122 (the VCO 110) starts to operate, the supply circuit 130 supplies a current to the gate of the control transistor 121 of the VCO 110 to suppress variation in the potential of the gate of the control transistor 121. This prevents the operation of the TDC 101 from becoming unstable at the startup. This also reduces crosstalk between the plurality of TDCs 101 arranged in the electronic circuit 100. This operation improves the distance measurement accuracy in the distance measurement device 200 provided with the electronic circuit 100.

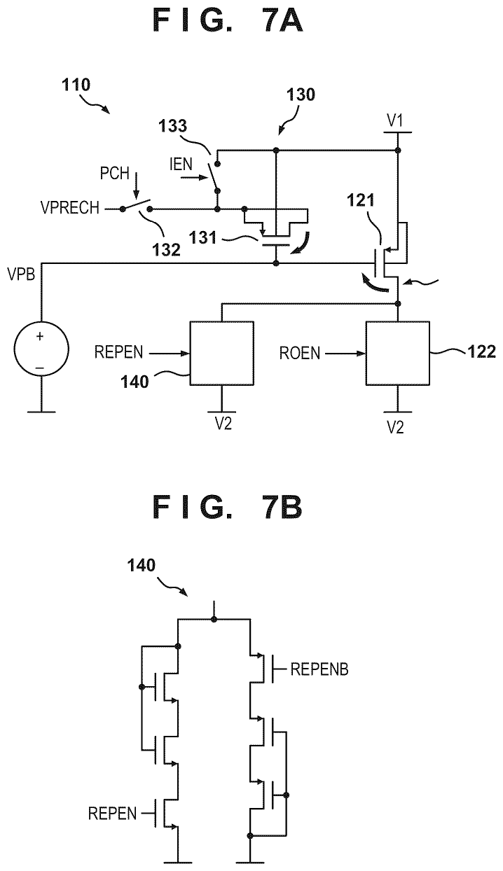

FIG. 7A is a circuit diagram showing a modification of the VCO 110 shown in FIG. 5. As described above, the VCOs 110 arranged in the plurality of TDCs 101 arranged in the electronic circuit 100 sometimes operate at different timings. According to the above description, at the startup of the VCO 110, a current momentarily starts to flow between the power supply line V1 and the power supply line V2, and charge injection occurs via the capacitance of the gate of the control transistor 121, thus causing variation in the potential of the gate of the control transistor 121. Accordingly, the VCO 110 includes the supply circuit 130 that flows a current for canceling out the charge injection current via the capacitance of the gate of the control transistor 121. On the other hand, the VCO 110 shown in FIG. 7A further includes a replica circuit 140 of the ring oscillator 122 to further stabilize the operation at the startup of the VCO 110. Other arrangements may be the same as the above arrangements, and hence the replica circuit 140 will be mainly described below.

The replica circuit 140 is arranged such that a current flows through the control transistor 121 between the power supply line V1 and the power supply line V2 when the ring oscillator 122 is inactive. For example, the replica circuit 140 can be configured such that a current flowing through the control transistor 121 at the startup of the replica circuit 140 is ½ or more of a current flowing through the control transistor 121 at the time of the operation of the ring oscillator 122. In addition, for example, the replica circuit 140 can be configured such that a current flowing through the control transistor 121 at the time of the operation of the ring oscillator 122 is almost the same as a current flowing through the control transistor 121 at the time of the operation of the replica circuit 140.

As shown in FIG. 7A, the replica circuit 140 operates in accordance with a control signal REPEN. FIG. 7B is a circuit diagram showing an example of the arrangement of the replica circuit 140. When the control signal REPEN is set in the High state, the transistor of the replica circuit 140 shown in FIG. 7B is rendered conductive, and a current flows through the control transistor 121. A control signal REPENB is a signal obtained by inversing the control signal REPEN. The synchronization circuit 150 can supply the control signal REPEN (REPENB) similar to the control signals EN, PCH, IENB, and ROEN described above.

For example, the transistor arranged in the replica circuit 140 may have almost the same structure as that of the transistor arranged in the ring oscillator 122. For example, the transistor arranged in the replica circuit 140 may have the same gate length or gate width as that of the transistor arranged in the ring oscillator 122. However, limitation is not made thereto, and it is at least required that a current flows through the control transistor 121 between the power supply line V1 and the power supply line V2 when the ring oscillator 122 is inactive. This suppresses the above charge injection current caused when a current momentarily flows at the startup of the ring oscillator 122. As a result, this suppresses variation in the power supply voltage supplied to the TDC 101 or variation in the control voltage VPB of the VCO 110.

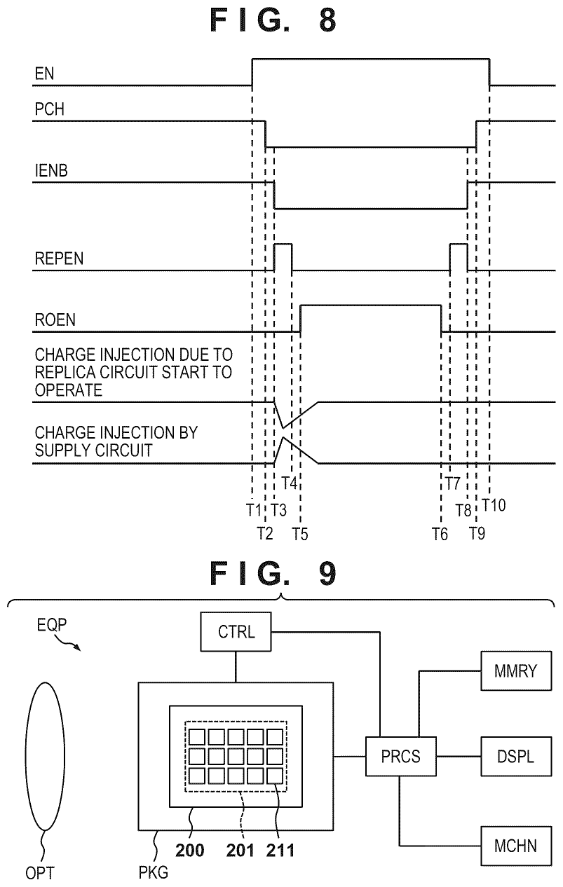

FIG. 8 is a timing chart showing the operation of the VCO 110 including the replica circuit 140. At time T1, as the control signal EN is set in the High state, the TDC 101 starts to operate. When the TDC 101 starts to operate, the control signal PCH changes to the Low state at time T2. At time T3, the control signal IENB changes to the Low state, and the control signal REPEN changes to the High state. This causes the replica circuit 140 to start to operate before the start of the operation of the ring oscillator 122.

At time T3, the replica circuit 140 starts to operate in accordance with the control signal REPEN. At the startup of the replica circuit 140 after the start of the operation of the TDC 101, as at the startup of the ring oscillator 122 shown in FIG. 6, charge injection occurs as a current momentarily flows. On the other hand, the switch element 133 is rendered conductive in accordance with the control signal IENB. Accordingly, a charge injection current flows from the gate capacitance of the supply transistor 131 of the supply circuit 130. As a result, both the charge injection currents cancel out to suppress variation in the control voltage VPB and variation in the power supply voltage supplied to each TDC 101.

For example, the control signal IENB and the control signal REPEN are signals obtained by delaying the control signal EN by a predetermined time more than the control signal PCH. The control signal IENB and the control signal REPEN can be common signals whose states are displaced at the same timing. It can be said that the supply circuit 130 and the replica circuit 140 start to operate in response to the common signal. More specifically, before the start of the operation of the ring oscillator 122, the replica circuit 140 starts to operate in response to the common signal, and the supply circuit 130 starts to supply a current to the gate of the control transistor 121.

After the startup of the replica circuit 140, at time T4, the control signal REPEN changes to the Low state. At time T5, the control signal ROEN changes to the High state. That is, the ring oscillator 122 starts to operate in response to the stop of the replica circuit 140. This suppresses a change in current flowing through the control transistor 121 and suppresses variation in the control voltage VPB and variation in the power supply voltage supplied to each TDC 101.

At time T6, the control signal ROEN changes to the Low state. At time T7, the control signal REPEN changes to the High state. That is, the replica circuit 140 starts to operate in response to the stop of the ring oscillator 122. This prevents a current from momentarily stopping to flow through the control transistor 121 as the ring oscillator 122 stops. This makes it possible to suppress variation in power supply voltage common to the plurality of TDCs 101 when the ring oscillator 122 (the VCO 110) of a given TDC 101 of the plurality of TDCs 101 stops. That is, it is possible to suppress crosstalk with respect to the operation of the other TDC 101 (the VCO 110) in operation.

Subsequently, before the control signal EN is set in the Low state, at time T8, the control signal IENB changes to the High state, and the control signal REPEN changes to the Low state, thus stopping the operation of the replica circuit 140. At time T9, the control signal PCH may be set in the High state to charge the gate capacitance of the supply transistor 131 of the supply circuit 130 to prepare for the next operation of the VCO 110. At time T10, as the control signal EN is set in the Low state, the TDC 101 stops operating.

The control signal EN may be a signal common to the plurality of TDCs 101 arranged in the electronic circuit 100. A change in the control signal PCH supplied at time T2 and changes in the control signals IENB and REPEN supplied at time T3 each may be a signal common to the plurality of TDCs 101 arranged in the electronic circuit 100. That is, the replica circuits 140 respectively arranged in the plurality of TDCs 101 arranged in the electronic circuit 100 may be configured to simultaneously start to operate before the start of the operation of the ring oscillator 122. In contrast to this, the ring oscillators 122 may operate at different timings between the plurality of TDCs 101. That is, the control signals ROEN may be set in the High state at different timings from time T5 to time T6 between the plurality of TDCs 101. The control signals REPEN indicated by time T4 may be set in the Low state at different timings between the plurality of TDCs 101 in accordance with the timing of time T5. Likewise, the control signals REPEN indicated by time T7 may be set in the Low state at different timings between the plurality of TDCs 101 in accordance with the timing of time T6. The above operation will suppress variation in the control voltage VPB and crosstalk between the plurality of TDCs 101 not only at the startup of the ring oscillator 122 but also at the stop of the ring oscillator 122.

An interval is provided between time T4 and time T5 shown in FIG. 8 to prevent a large current from flowing through the control transistor 121 as the ring oscillator 122 and the replica circuit 140 simultaneously operate. The same applies to the interval between time T6 and time T7.

An application example of the distance measurement device 200 including the electronic circuit 100 including the plurality of TDCs 101 according to the above embodiment will be described below. FIG. 9 is a schematic view of equipment EQP on which the distance measurement device 200 is mounted. The distance measurement device 200 can be a semiconductor chip having a multilayer structure provided with the pixel circuit 201 in which the pixels 211 are arranged. As shown in FIG. 9, the distance measurement device 200 is accommodated in a semiconductor package PKG. The package PKG can include a base to which the distance measurement device 200 is fixed, a lid such as glass facing the distance measurement device 200, and a conductive connecting member such as a bonding wire or bump used to connect a terminal provided on the base to a terminal provided on the distance measurement device 200. The equipment EQP may further include at least one of a control device CTRL, a processing device PRCS, a display device DSPL, and a storage device MMRY.

An optical system OPT forms an image on the pixel circuit 201, and can be, for example, a lens, a shutter, and a mirror. The control device CTRL controls the operation of the distance measurement device 200, and can be, for example, a semiconductor device such as an ASIC or the like. The processing device PRCS processes a signal output from the distance measurement device 200, and can be, for example, a semiconductor device such as a CPU, an ASIC, or the like. The display device DSPL can be an EL display device or a liquid crystal display device that displays data obtained by the distance measurement device 200. The storage device MMRY is a magnetic device or a semiconductor device for storing data obtained by the distance measurement device 200. The storage device MMRY can be a volatile memory such as an SRAM, a DRAM, or the like or a nonvolatile memory such as a flash memory or a hard disk drive. A mechanical device MCHN can include a moving or propulsion unit such as a motor or an engine. The mechanical device MCHN drives the components of the optical system OPT for zooming, focusing, and shutter operations. In the equipment EQP, data output from the distance measurement device 200 is displayed on the display device DSPL, or transmitted to an external device by a communication device (not shown) included in the equipment EQP. Hence, the equipment EQP may also include the storage device MMRY and the processing device PRCS.

The equipment EQP incorporating the distance measurement device 200 is also applicable to a surveillance camera or an onboard camera mounted in a transportation equipment such as an automobile, a railroad car, a ship, an airplane, or an industrial robot. In addition, the equipment EQP incorporating the distance measurement device 200 is not limited to transportation equipment but is also applicable to equipment that widely uses object recognition, such as an intelligent transportation system (ITS).

The TDC 101 including the supply circuit 130 and the replica circuit 140 described above is not limited to being used in the distance measurement device 200. The TDC 101 may be used in, for example, a PLL circuit. The PLL circuit including the TDC 101 including the supply circuit 130 and the replica circuit 140 can be used in, for example, a wireless communication circuit. In addition, for example, the TDC 101 including the supply circuit 130 and the replica circuit 140 may be applied to an AD conversion circuit.

According to the present disclosure, it is possible to provide a technique advantageous in stabilizing the operation of the time-to-digital converter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168869, filed Sep. 28, 2023, which is hereby incorporated by reference herein in its entirety.

What is claimed is:

1. An electronic circuit comprising a plurality of time-to-digital converters,
wherein each of the plurality of time-to-digital converters comprises a voltage-controlled oscillator configured to generate a multiphase clock,
each voltage-controlled oscillator comprises a control transistor which is arranged between a first power supply line and a second power supply line and includes a gate to which a control voltage is input, and
each voltage-controlled oscillator further comprises a supply circuit configured to supply a current to the gate.

2. The circuit according to claim 1, wherein the supply circuit comprises a capacitive element arranged between the first power supply line and the gate, a first switch element configured to charge the capacitive element, and a second switch element configured to supply a current to the gate.

3. The circuit according to claim 2, wherein the supply circuit comprises a supply transistor configured to supply a current to the gate of the control transistor,
a source and a drain of the supply transistor are connected to a third power supply line via the first switch element and are connected to the first power supply line via the second switch element,
a gate of the supply transistor is connected to the gate of the control transistor,
a body of the supply transistor is connected to the first power supply line, and
a gate capacitance of the supply transistor functions as the capacitive element.

4. The circuit according to claim 1, wherein the supply circuit reduces variation in potential of the gate by charge injection via a capacitance of the gate at a startup time of the voltage-controlled oscillator.

5. The circuit according to claim 4, wherein the supply circuit supplies a current in an opposite direction to a current flowing between the gate of the control transistor and the supply circuit due to the charge injection to the gate of the control transistor.

6. The circuit according to claim 1, wherein the voltage-controlled oscillator arranged in each of the plurality of time-to-digital converters individually comprises a terminal to which a signal for starting an operation is input.

7. The circuit according to claim 1, wherein the voltage-controlled oscillator further includes a ring oscillator arranged between the control transistor and the second power supply line.

8. The circuit according to claim 7, wherein the ring oscillator starts to operate and the supply circuit starts to supply a current to the gate of the control transistor in response to a common signal.

9. The circuit according to claim 7, wherein each voltage-controlled oscillator further comprises a replica circuit of the ring oscillator, and
the replica circuit starts to operate before the ring oscillator starts to operate, and the ring oscillator then starts to operate in response to stopping of the replica circuit.

10. The circuit according to claim 9, wherein the replica circuit further starts to operate in response to stopping of the ring oscillator.

11. The circuit according to claim 9, wherein the replica circuits respectively arranged in the plurality of time-to-digital converters are configured to start to operate simultaneously before the ring oscillator starts to operate.

12. The circuit according to claim 9, wherein a current flowing through the control transistor at time of operation of the replica circuit is not less than ½ of a current flowing through the control transistor at time of operation of the ring oscillator.

13. The circuit according to claim 9, wherein the replica circuit is configured to equalize a current flowing through the control transistor at time of operation of the ring oscillator with a current flowing through the control transistor at time of operation of the replica circuit.

14. The circuit according to claim 9, wherein the replica circuit starts to operate and the supply circuit starts to supply a current to the gate of the control transistor in response to a common signal before the ring oscillator starts to operate.

15. A distance measurement device comprising:
a plurality of pixels; and
a generating circuit configured to generate distance information based on signals obtained by the plurality of pixels,
wherein the generating circuit includes the electronic circuit according to claim 1.

16. The device according to claim 15, wherein each of the plurality of pixels comprises an avalanche photodiode.

17. Equipment comprising:
the distance measurement device according to claim 15; and
a processing device configured to process a signal output from the distance measurement device.
